(19) United States
(12) Patent Application Publication
(10) Pub. No.: US 2025/0270066 A1
(43) Pub. Date: Aug. 28, 2025

(54) AUTOMATIC DOCUMENT FEEDER AND IMAGE FORMING APPARATUS

(71) Applicant: Yosuke IIDA, Kanagawa (JP)

(72) Inventor: Yosuke IIDA, Kanagawa (JP)

(73) Assignee: Ricoh Company, Ltd., Tokyo (JP)

(21) Appl. No.: 19/053,889

(22) Filed: Feb. 14, 2025

(30) Foreign Application Priority Data
Feb. 28, 2024 (JP) 2024-029075

(51) Int. Cl. B65H 29/22

(52) U.S. Cl. CPC B65H 29/22; B65H 2553/30

(57) ABSTRACT

An automatic document feeder includes a document stacker, a document conveyor, a sound generator, a sound collector, and circuitry. The document stacker is a receptacle on which a document is placed. The document conveyor conveys the document on the document stacker along a document conveyance path in a conveyance direction. The sound generator is on a surface of the document conveyance path, and has a protrusion or a recess protruding or recessed from the surface of the document conveyance path, and extending continuously or intermittently from one end to another end of the document conveyance path in a width direction orthogonal to the conveyance direction. The sound collector collects sound generated by contact between the sound generator and a fastening object attached to the document. The circuitry is to predict whether the fastening object is attached to the document, based on the sound collected by the sound collector.

### CROSS-REFERENCE TO RELATED APPLICATION

This patent application is based on and claims priority pursuant to 35 U.S.C. § 119 (a) to Japanese Patent Application No. 2024-029075, filed on Feb. 28, 2024, in the Japan Patent Office, the entire disclosure of which is hereby incorporated by reference herein.

### BACKGROUND

### Technical Field

Embodiments of the present disclosure relate to an automatic document feeder and an image forming apparatus.

### Background Art

Typical automatic document feeders continuously feeds multiple sheet-like documents placed on a document tray one by one toward an image reading position of a scanner as a document reader. Such automatic document feeders have been considered to determine a jam (paper jam) or a wrinkle by sound. For example, a medium feeding device in the art is disclosed to include a sound detector disposed downstream from a feeder in a feeding direction and determine occurrence of a jam when the sound volume exceeds a threshold value. In addition, the medium feeding device is also disclosed to include a contactor and detect wrinkles by detecting sound generated by contact of a medium and the contactor.

However, the medium feeding device in the art does not have a countermeasure to prevent a possible cause of jam when a fastening object such as a clip is attached to the original document. Due to such a configuration, when an original document is conveyed with a fastening object attached to the original document, no sound occurs after the fastening object passes by the contactor, and the medium feeding device in the art fails to detect the fastening object.

### SUMMARY

Embodiments of the present disclosure described herein provide a novel automatic document feeder including a document stacker, a document conveyor, a sound generator, a sound collector, and circuitry. The document stacker is a receptacle on which a document is placed. The document conveyor conveys the document on the document stacker along a document conveyance path in a conveyance direction. The sound generator is disposed on a surface of the document conveyance path. The sound generator has a protrusion or a recess protruding or recessed from the surface of the document conveyance path, and extending continuously or intermittently from one end to another end of the document conveyance path in a width direction orthogonal to the conveyance direction. The sound collector collects sound generated by contact between the sound generator and a fastening object attached to the document. The circuitry is to predict whether the fastening object is attached to the document, based on the sound collected by the sound collector.

Further, embodiments of the present disclosure described herein provide an image forming apparatus including the above-described automatic document feeder, and an image forming device to form an image on a medium.

Further, embodiments of the present disclosure described herein provide an automatic document feeder including a document path, a protrusion, and a sound collector. The document conveyance path is a path in which a document is conveyed to a reading position to read the document. The protrusion extends in a direction orthogonal to a conveyance direction of the document in the document conveyance path and protrudes upward toward a downstream side from an upstream side in the document conveyance path of the conveyance direction of the document, to contact a surface of the document that conveys in the document conveyance path. The sound collector collects sound of the document that conveys in the document conveyance path. Conveyance of the document to be conveyed to the reading position is stopped based on the sound collected by the sound collector.

Further, embodiments of the present disclosure described herein provide an image forming apparatus including the above-described automatic document feeder, and an image forming device to form an image on a medium.

### BRIEF DESCRIPTION OF THE SEVERAL VIEWS OF THE DRAWINGS

Exemplary embodiments of this disclosure will be described in detail based on the following figures, wherein:

FIG. 1 is a schematic diagram illustrating a configuration of an image forming apparatus according to an embodiment of the present disclosure;

FIG. 2 is a partially enlarged view of a part of an image forming device according to an embodiment of the present disclosure;

FIG. 3 is a partially enlarged view of a part of a tandem section including four image forming units of an image forming device according to an embodiment of the present disclosure;

FIG. 4 is a perspective view of a scanner and an automatic document feeder according to an embodiment of the present disclosure;

FIG. 5 is a perspective view of an automatic document feeder according to an embodiment of the present disclosure;

FIG. 6 is a schematic diagram illustrating a configuration of an automatic document feeder according to an embodiment of the present disclosure;

FIG. 7 is a partially enlarged view of a main part of the automatic document feeder of FIG. 5;

FIG. 8 is a top view of a part of a document conveyance path according to an embodiment of the present disclosure;

FIG. 9 is a perspective view of a sound generator according to an embodiment of the present disclosure;

FIG. 10 is a perspective view of a sound generator according to a first modification of an embodiment of the present disclosure;

FIG. 11 is a schematic diagram illustrating an example of an original document to which a fastening object is attached;

FIG. 12 is a diagram illustrating conveyance of the original document of FIG. 11;

FIG. 13 is a schematic diagram illustrating another example of an original document to which a fastening object is attached;

FIG. 14 is a diagram illustrating conveyance of the original document of FIG. 13;

FIG. 15 is a perspective view of a sound generator according to a second modification of an embodiment of the present disclosure;

FIG. 16 is a perspective view of a sound generator according to a third modification of an embodiment of the present disclosure;

FIG. 17 is a perspective view of a sound generator according to a fourth modification of an embodiment of the present disclosure;

FIG. 18 is a top view of a part of the document conveyance path according to the first modification of an embodiment of the present disclosure;

FIG. 19 is a diagram illustrating the part of the document conveyance path of FIG. 18, viewed from the upstream side in the conveyance direction;

FIG. 20 is a side view of the part of the document conveyance path of FIG. 18;

FIG. 21 is a perspective view of a sound generator according to a fifth modification of an embodiment of the present disclosure;

FIG. 22 is a top view of a part of the document conveyance path according to the second modification of an embodiment of the present disclosure;

FIG. 23 is an enlarged perspective view of a part of the document conveyance path of

FIG. 22;

FIG. 24 is a top view of a part of the document conveyance path of the automatic document feeder according to another example of an embodiment of the present disclosure;

FIG. 25 is a block diagram illustrating a part of an electric circuit of an image forming apparatus according to an embodiment of the present disclosure; and

FIG. 26 is a flowchart of a fastening object determination process executed by a controller according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below.] The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below in detail with reference to the drawings. Like reference signs are assigned to identical or equivalent components and a description of those components may be simplified or omitted.

The following describes an image forming apparatus according to an embodiment of the present disclosure. Descriptions are given of an image forming apparatus, for example, an electrophotographic copier, in the following embodiments, according to an embodiment of the present disclosure.

A basic structure of the image forming apparatus according to the present embodiment is firstly described.

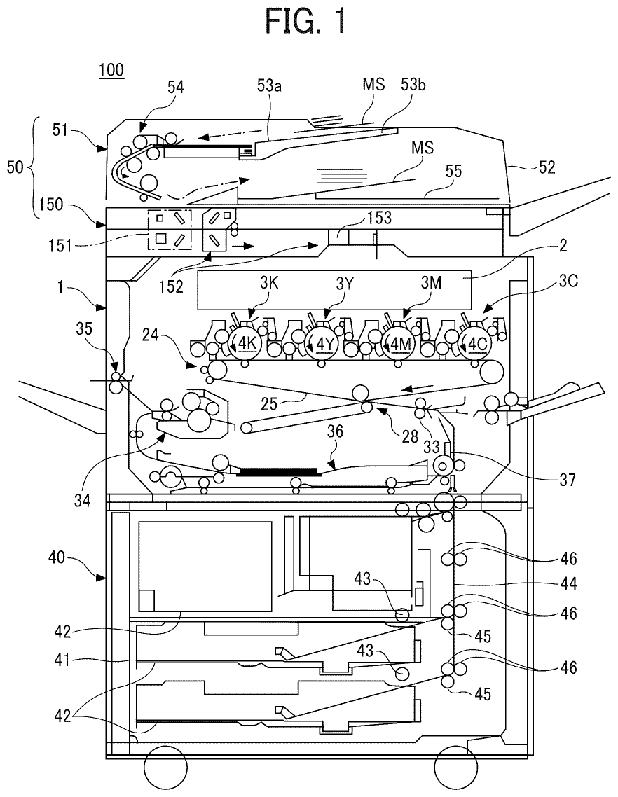

FIG. 1 is a schematic diagram illustrating a configuration of an image forming apparatus 100 according to an embodiment of the present disclosure.

As illustrated in FIG. 1, the image forming apparatus 100 includes an image forming device 1 that forms an image on a sheet-like medium, a sheet feeding device 40, and an image reading system 50. The image reading system 50 includes a scanner 150 as an image reading device that is fixed on the image forming device 1, and an automatic document feeder 51 (ADF 51) supported by the scanner 150.

The sheet feeding device 40 includes a paper bank 41, multiple sheet trays 42 disposed one above the other in the paper bank 41, sheet feed rollers 43 each of which picking up a recording sheet from a selected one of the multiple sheet trays 42, and a sheet separation roller 45 that separates the recording sheets fed by the sheet feed rollers 43. The sheet feeding device 40 further includes multiple conveyance roller pairs 46 that convey the recording sheet in a sheet conveyance path 37 as a conveyance path in the image forming device 1.

The multiple sheet trays 42 contains multiple recording sheets overlapping each other in a form of a sheet bundle. The sheet feed roller 43 presses and contacts the uppermost sheet of the multiple recording sheets on each of the multiple sheet trays 42. As the sheet feed roller 43 rotates, the uppermost recording sheet of the sheet bundle is fed from the selected one of the sheet trays 42.

The multiple conveyance roller pairs 46 are disposed near the multiple sheet trays 42. Each of the multiple conveyance roller pairs 46 includes a first conveyance roller and a second conveyance roller adjacent to (on the right side of FIG. 1) the first conveyance roller. The first conveyance roller and the second conveyance roller of each of the multiple conveyance roller pairs 46 are in contact with each other to form a conveyance nip region.

A sheet separation roller 45 is disposed below the first conveyance roller of each of the multiple conveyance roller pairs 46 and is in contact with the first conveyance roller from below to form a separation conveyance nip region.

A recording sheet fed from one of the sheet trays 42 driven and rotated by a corresponding one of the sheet feed rollers 43 enters the separation conveyance nip region formed by the contact of the first conveyance roller of each of the multiple conveyance roller pairs 46 and the sheet separation roller 45 disposed below the first conveyance roller. In the separation conveyance nip region, the first conveyance roller that contacts the upper face of the recording sheet applies a conveyance force to the recording sheet from the sheet tray 42 toward a sheet feeding path 44 as the first conveyance roller is driven and rotated in the counterclockwise direction in FIG. 1. In contrast, the sheet separation roller 45 that is in contact with the lower face of the recording sheet applies a conveyance force to the recording sheet from the sheet feeding path 44 toward the sheet tray 42 as the sheet separation roller 45 is driven and rotated in the counterclockwise direction in FIG. 1, thereby returning the recording sheet to the sheet tray 42.

When only one recording sheet is fed from the sheet tray 42, the first conveyance roller and the sheet separation roller 45 apply the conveyance force to the recording sheet toward opposite directions to each other in the separation conveyance nip region. As a result, a load exceeding a given threshold value is applied to the drive transmission part of the sheet separation roller 45. Then, a torque limiter disposed in the drive transmission part of the sheet separation roller 45 is operated to cut off the transmission of the driving force from a DC brushless motor to the sheet separation roller 45. Accordingly, the sheet separation roller 45 is rotated with the recording sheet that is conveyed by the first conveyance roller, and the recording sheet is then ejected from the separation conveyance nip region to the sheet feeding path 44.

On the other hand, when the multiple recording sheets are fed from the sheet tray 42 with the multiple recording sheets overlapped to each other, the first conveyance roller applies the conveyance force to the uppermost recording sheet of the multiple recording sheets from the sheet tray 42 toward the sheet feeding path 44 in the separation conveyance nip region. Then, the uppermost recording sheet of the multiple recording sheets is fed from the separation conveyance nip region toward the sheet feeding path 44. On the other hand, the sheet separation roller 45 applies the conveyance force from the sheet feeding path 44 toward the sheet tray 42 to the lower recording sheet or sheets of the multiple recording sheets, so that the lower recording sheet is (or sheets are) reversed from the separation conveyance nip region toward the sheet tray 42. Accordingly, in the separation conveyance nip region, the uppermost recording sheet is separated from other recording sheet or sheets so as to be conveyed alone to the sheet feeding path 44.

The recording sheet on the sheet feeding path 44 enters the conveyance nip region of the conveyance roller pair 46 where the conveyance force is applied upward from below in the vertical direction. Accordingly, the recording sheet is conveyed toward the sheet conveyance path 37 of the image forming device 1 in the sheet feeding path 44.

The image forming device 1 includes an optical writing device 2 and four image forming units 3K, 3Y, 3M, and 3C. The image forming units 3K, 3Y, 3M, and 3C form black, yellow, magenta, and cyan toner images, respectively. The image forming device 1 further includes a transfer unit 24, a sheet conveyance unit 28, a registration roller pair 33, a fixing device 34, a switchback device 36, and the sheet conveyance path 37. The optical writing device 2 includes a light source such as a laser diode and a light emitting diode (LED). The light source is disposed in the optical writing device 2. By driving the light source in the optical writing device 2, laser lights L are emitted toward four drum-shaped photoconductors 4K, 4Y, 4M, and 4C to irradiate respective surfaces of the drum-shaped photoconductors 4K, 4Y, 4M, and 4C. Due to this irradiation, electrostatic latent images of respective single colors are formed on the surfaces of the photoconductors 4K, 4Y, 4M, and 4C, which will be developed to visible toner images via a given development process.

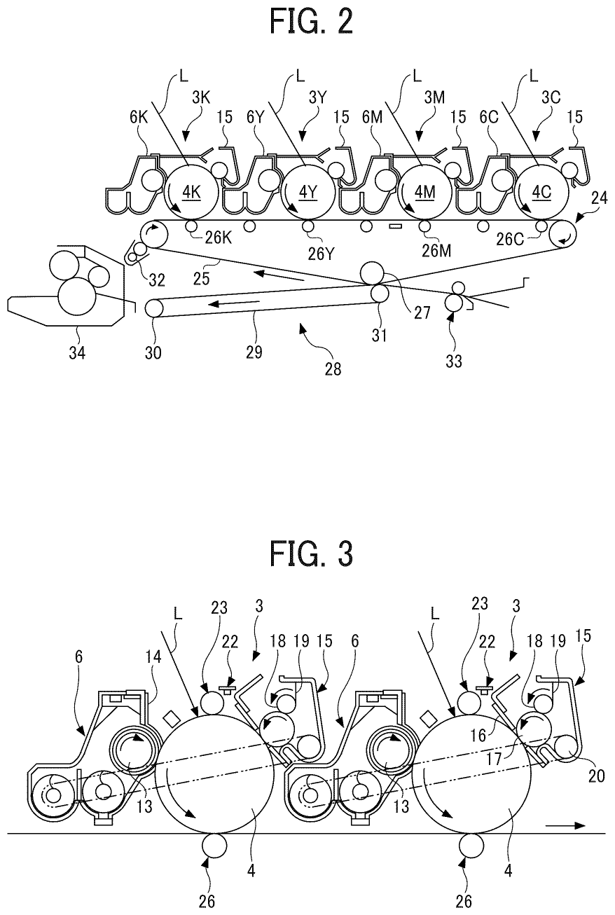

FIG. 2 is a partially enlarged view of a part of the image forming device 1 according to an embodiment of the present disclosure.

FIG. 3 is a partially enlarged view of a tandem section including the four image forming units 3K, 3Y, 3M, and 3C of the image forming device 1 according to an embodiment of the present disclosure.

Since the four image forming units 3K, 3Y, 3M, and 3C have respective configurations substantially the same as each other except the toner colors, the image forming units 3K, 3Y, 3M, and 3C are also described without suffixes indicating the toner colors, which are K, Y, M, and C in FIG. 3. For example, the image forming units 3K, 3Y, 3M, and 3C are referred to as a “process unit 3” in a single form occasionally.

The image forming units 3K, 3Y, 3M, and 3C also include respective image forming components disposed around each of the photoconductors 4K, 4Y, 4M, and 4C as a single unit supported by a common support member, respectively. The image forming units 3K, 3Y, 3M, and 3C are detachably attached to the image forming device 1 of the image forming apparatus 100. The image forming unit (i.e., the image forming units 3K, 3Y, 3M, and 3C) includes the photoconductor 4 (i.e., the photoconductors 4K, 4Y, 4M, and 4C), and a charging device 23, the developing device 6 (i.e., the developing devices 6K, 6Y, 6M, and 6C), the drum cleaning device 15 (i.e., the drum cleaning devices 15K, 15Y, 15M, and 15C), and an electric discharging lamp 22 around the photoconductor 4. The image forming apparatus 100 is a tandem image forming apparatus in which the four image forming units 3K, 3Y, 3M, and 3C are aligned in a direction of movement of an intermediate transfer belt 25 as an endless loop.

The photoconductor 4 is manufactured by a hollow tube made of aluminum, for example, with a drum shape covered by an organic photoconductive layer having photosensitivity. The photoconductor 4 may have a shape of endless belt.

The developing device 6 develops an electrostatic latent image into a visible toner image by a two-component developer including magnetic carrier particles and non-magnetic toner. The two-component developer is now referred to as a “developer”. The developing device 6 includes an agitating portion 7 and a development portion 11. The agitating portion 7 stirs the two-component developer accommodated therein and conveys the two-component developer to a development sleeve 12. The development portion 11 supplies the non-magnetic toner, which is included in the two-component developer and held by the development sleeve 12, to the photoconductor 4.

The agitating portion 7 is located at a position lower than the development portion 11 and includes two screw, a partition, a development case 9, and a toner concentration sensor 10. The two transfer screws 8 are disposed in parallel to each other. The partition is disposed between the two transfer screws 8. The development case 9 has an opening or a slot to face the photoconductor 4. The toner concentration sensor 10 is disposed on the bottom of the development case 9.

The development portion 11 includes the development sleeve 12, a magnetic roller 13, and a doctor blade 14. The development sleeve 12 faces the photoconductor 4 through the opening (or the slot) of the development case 9. The magnetic roller 13 is fixedly or unrotatably disposed inside the development sleeve 12. The doctor blade 14 is disposed adjacent to the development sleeve 12 and the leading end of the doctor blade 14 is disposed close to the development sleeve 12. The development sleeve 12 has a non-magnetic, rotatable tubular body. The magnetic roller 13 has multiple magnetic poles arranged in the order in a rotation direction of the development sleeve 12, starting from an opposed position to the doctor blade 14. Each of these magnetic poles applies a magnetic force at a predetermined position in the rotation direction of the development sleeve 12, with respect to the two-component developer supplied on the development sleeve 12. With this action of the magnetic roller 13, the two-component developer that is conveyed from the agitating portion 7 is attracted and attached to the surface of the development sleeve 12 and a magnetic brush of toner is formed along the lines of the magnetic force on the surface of the development sleeve 12.

In accordance with rotation of the development sleeve 12, the magnetic brush is regulated to have an appropriate layer thickness when passing by the opposed position to the doctor blade 14. Then, the magnetic brush is moved to a development region facing the photoconductor 4. Due to a difference of potentials between a development bias that is applied to the development sleeve 12 and an electrostatic latent image formed on the surface of the photoconductor 4, the toner is transferred onto the electrostatic latent image, so that the electrostatic latent image is developed into a visible toner image. Further, after returning into the development portion 11 again along with the rotation of the development sleeve 12 then leaving from the surface of the development sleeve 12 due to repulsion of the magnetic field formed between the magnetic poles of the magnetic roller 13, the two-component developer in a form of the magnetic brush is returned to the agitating portion 7. An appropriate amount of toner is supplied to the two-component developer in the agitating portion 7 based on a result or results detected by the toner concentration sensor 10. Alternative to the two-component developer, the developing device 6 according to the present embodiment may employ one-component developer that does not include magnetic carriers.

The drum cleaning device 15 includes a cleaning blade 16, a fur brush 17, an electric field roller 18, a scraper 19, a collection screw 20, and an external toner recycling transfer device 21. The cleaning blade 16 is an elastic member to be pressed against the photoconductor 4, so as to scrape residual toner remaining on the surface of the photoconductor 4. In the present embodiment, the drum cleaning device 15 employs a blade member such as the cleaning blade 16, however, the configuration is not limited thereto. Alternative to the blade member, a brush roller, for example, can be applied to the drum cleaning device 15. The fur brush 17 according to the present embodiment is provided in order to increase the cleanability. The fur brush 17 is a conductive member and the outer circumferential face of the fur brush 17 slidably contacts the photoconductor 4. The fur brush 17 according to the present embodiment is rotatable in a direction indicated by arrow in FIG. 3.

The fur brush 17 also functions as an applier that scrapes a solid lubricant to obtain fine powder of lubricant and applies the scraped fine powder to the surface of the photoconductor 4. The electric field roller 18 is a metallic member that applies a bias to the fur brush 17. The electric field roller 18 is disposed rotatably in a direction indicated by arrow in FIG. 3. The scraper 19 has a leading end that is pressed against the electric field roller 18. The toner removed from the photoconductor 4 and attached to the fur brush 17 is transferred onto the electric field roller 18 that contacts the fur brush 17 in a counter direction to be applied with a bias while the electric field roller 18 is rotating. After being scraped and removed from the electric field roller 18 by the scraper 19, the toner falls onto the collection screw 20. The collection screw 20 conveys the toner collected from the surface of the photoconductor 4 toward an end portion of the drum cleaning device 15 in a direction orthogonal to the drawing sheet, and transfers the collected toner to the external toner recycling transfer device 21. The external toner recycling transfer device 21 sends the collected toner to the developing device 6 for recycling.

The electric discharging lamp 22 removes residual electric charge remaining on the surface of the photoconductor 4 by photo irradiation. After such residual electric charge is removed, the electrically discharged surface of the photoconductor 4 is uniformly charged by the charging device 23 again and then optically irradiated by the optical writing device 2. In the image forming apparatus 100 according to the present embodiment, the charging device 23 is a charging roller that is applied with charging bias and rotates while contacting the photoconductor 4. However, in some embodiments, the charging device 23 may be a scorotron charger that performs a charging process on the photoconductor 4 in non-contact with the photoconductor 4.

According to the above-described operations with the configuration illustrated in FIG. 2, black (K), yellow (Y), magenta (M), and cyan (C) toner images are formed on the photoconductors 4K, 4Y, 4M, and 4C of the image forming units 3K, 3Y, 3M, and 3C, respectively. The transfer unit 24 is disposed below the four image forming units 3K, 3Y, 3M, and 3C.

The transfer unit 24 endlessly moves the intermediate transfer belt 25 in the clockwise direction in FIG. 2 while the intermediate transfer belt 25 is stretched by and would around multiple rollers and is in contact with the photoconductors 4K, 4Y, 4M, and 4C. By so doing, respective primary transfer nip regions for forming black, yellow, magenta, and cyan images are formed between the photoconductors 4K, 4Y, 4M, and 4C and the intermediate transfer belt 25. In proximity to each of the primary transfer nip regions for black, yellow, magenta, and cyan images, the primary transfer rollers 26 (i.e., the primary transfer rollers 26K, 26Y, 26M, and 26C) are disposed in contact with the inner loop of the intermediate transfer belt 25 to press the intermediate transfer belt 25 against the photoconductors 4 (i.e., the photoconductors 4K, 4Y, 4M, and 4C), respectively. A primary transfer bias is applied by respective transfer bias power supplies to the primary transfer rollers 26K, 26Y, 26M, and 26C. Consequently, respective primary transfer electric fields are generated in the primary transfer nip regions to electrostatically transfer respective black, yellow, magenta, and cyan toner images formed on the photoconductors 4K, 4Y, 4M, and 4C onto the intermediate transfer belt 25.

As the intermediate transfer belt 25 passes through the primary transfer nip regions along the endless rotation in the clockwise direction in FIG. 2, the black, yellow, magenta, and cyan toner images are sequentially transferred at the primary transfer nip regions and overlaid onto an outer circumferential surface of the intermediate transfer belt 25. Due to the primary transfer of the toner images, a four-color composite toner image (referred to as a four-color toner image) is formed on the surface of the intermediate transfer belt 25.

The sheet conveyance unit 28 is disposed below the transfer unit 24 in FIG. 2. The sheet conveyance unit 28 includes a sheet transfer belt 29, a sheet transfer belt drive roller 30, and a secondary transfer roller 31. The sheet transfer belt 29 is an endless belt that is wound around the sheet transfer belt drive roller 30 and the secondary transfer roller 31 and rotates in a direction indicated by arrow in FIG. 2. As illustrated in FIG. 2, the intermediate transfer belt 25 and the sheet transfer belt 29 are sandwiched between the secondary transfer roller 31 and a lower tension roller 27 of the transfer unit 24. According to this configuration, a secondary transfer nip region is formed between the surface of the intermediate transfer belt 25 and the surface of the sheet transfer belt 29 contacting with each other. A secondary transfer bias is applied by a transfer bias power source to the secondary transfer roller 31. On the other hand, the lower tension roller 27 of the transfer unit 24 is electrically grounded. By so doing, a secondary transfer electric field is formed in the secondary transfer nip region.

The registration roller pair 33 is disposed on a right side of the secondary transfer nip region in FIGS. 2 and 3. A registration roller sensor is disposed adjacent to an entrance of the registration nip region of the registration roller pair 33. The recording sheet is conveyed from a sheet feeding device to the registration roller pair 33. After a given time has elapsed from the detection of the leading end of the recording sheet by the registration roller sensor, the conveyance of the recording sheet temporarily stops, and the leading end of the recording sheet contacts the registration nip region of the registration roller pair 33.

After the leading end of the recording sheet contacts the registration nip region of the registration roller pair 33, the registration roller pair 33 restarts the rotation to synchronize the movement of the recording sheet with the movement of the four-color toner image formed on the intermediate transfer belt 25. Consequently, the recording sheet nipped between the registration roller pair 33 is conveyed to the secondary transfer nip region. When the four-color toner image formed on the intermediate transfer belt 25 closely contacts the recording sheet at the secondary transfer nip region, the four-color toner image on the intermediate transfer belt 25 is transferred onto the recording sheet in the secondary transfer due to the secondary transfer electric field and the nip pressure. At this time, the four-color toner image is combined with white color of the recording medium to make a full-color image. After passing through the secondary transfer nip region, the recording sheet having the full-color toner image on the surface is separated from the intermediate transfer belt 25. Then, while being held on the front face of the sheet transfer belt 29, the recording sheet is conveyed to the fixing device 34 along with endless rotation of the sheet transfer belt 29 in the direction as illustrated in FIG. 3.

Residual toner that has not been transferred onto the recording sheet in the secondary transfer nip region remains on the surface of the intermediate transfer belt 25 after the intermediate transfer belt 25 has passed through the secondary transfer nip region. The residual toner is scraped and removed from the surface of the intermediate transfer belt 25 by a belt cleaning device 32 that is disposed in contact with the surface of the intermediate transfer belt 25.

The recording sheet is conveyed to the fixing device 34. The fixing device 34 fixes the full-color toner image to the recording sheet by application of heat and pressure. Then, the recording sheet is conveyed from the fixing device 34 to the sheet ejection roller pair 35 to be ejected to the outside of the image forming apparatus 100.

As illustrated in FIG. 1, the switchback device 36 is disposed below the sheet conveyance unit 28 and the fixing device 34. As a result of the above-described operation, after the image fixing operation is performed on one side or the surface of the recording sheet, the switching member of the switchback device 36 switches the direction of conveyance of the recording sheet. Specifically, the direction of conveyance of the recording sheet is switched to a path to a transfer reversal device by the switching member. When the recording sheet is conveyed to the transfer reversal device, the recording sheet is reversed to enter the secondary transfer nip region of the image forming apparatus 100 again. In the image forming apparatus 100, a toner image is secondarily transferred onto the other side or a back face of the recording sheet so that the secondary transfer process and the fixing process are executed. Then, the recording sheet is ejected onto the ejection tray.

The scanner 150 fixed to the image forming device 1 includes a fixed reading unit 321 and a movable reading unit 152. The scanner 150 and an automatic document feeder 51 (simply referred to as an ADF 51) include fixed reading units. The movable reading unit 152 is disposed immediately below a second exposure glass 155 (to be described below) that is fixed to the upper wall of a casing of the scanner 150 so as to contact an original document MS. The movable reading unit 152 includes a light source and optical process units such as multiple reflection mirrors, so that these optical units can move in a left and right direction in FIG. 1. In the course of moving the optical components from left to right in FIG. 1, the light source emits the light. After the surface of the original document MS placed on the second exposure glass 155 reflects the light, the reflected light is further reflected on multiple reflection mirrors until an image reading sensor 153 that is fixed to the scanner 150 receives the reflected light.

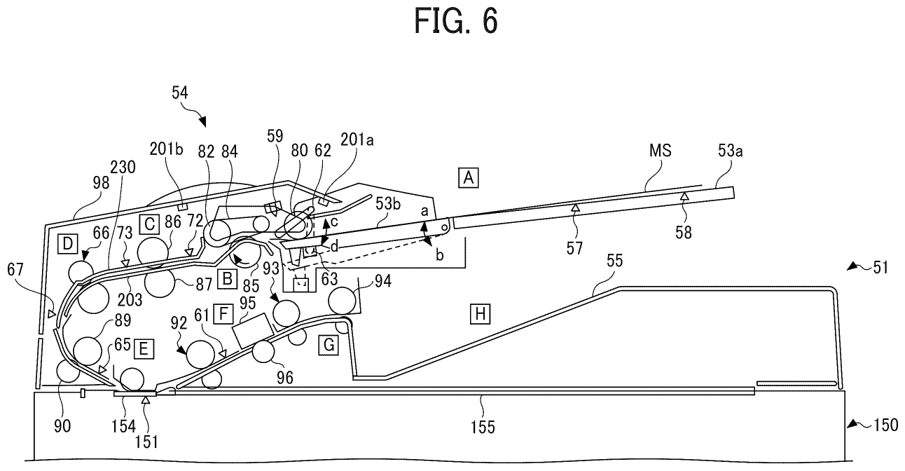

In contrast, the fixed reading unit includes the first fixed reading unit 151 disposed inside the scanner 150, and a second fixed reading unit 95 (see FIG. 6) disposed inside the ADF 51. The first fixed reading unit 151 includes a light source, multiple reflection mirrors, and the image reading sensor 153 such as CCD. The first fixed reading unit 151 is disposed immediately below a first exposure glass 154 (described below) that is fixed to the upper wall of the casing of the scanner 150, so that the first exposure glass 154 contacts the original document MS. When the sheet-like original document MS that is conveyed by the ADF 51 (described below) passes over the first exposure glass 154, the light source emits light. After a document face of the original document MS sequentially reflects the light emitted from the light source, the reflected light is further reflected on multiple reflection mirrors until the image reading sensor 153 receives the reflected light. By so doing, the first face of the original document MS is scanned without moving the optical components such as the light source and the multiple reflection mirrors. Further, the second fixed reading unit 95 scans or reads the second side or the back surface of the original document MS after the original document MS has passed the first fixed reading unit 151. The original document MS is a sheet-like member such as paper or film.

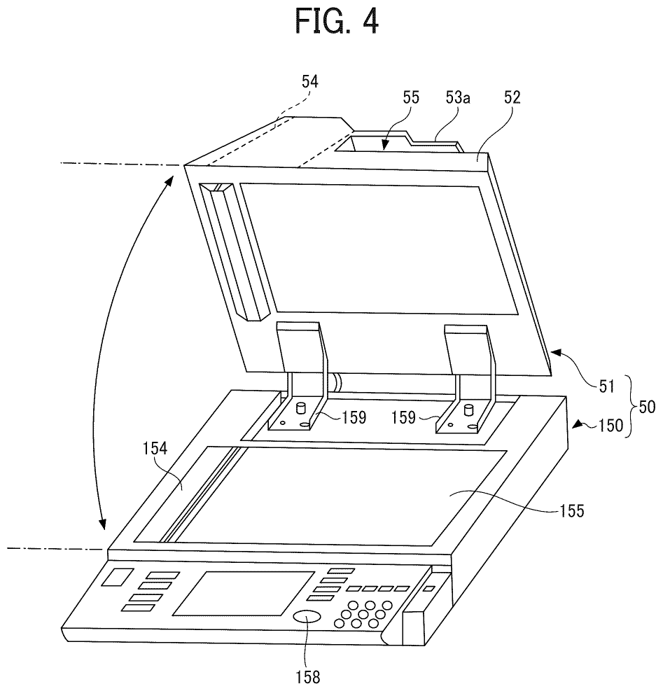

FIG. 4 is a perspective view of the scanner 150 and the ADF 51 according to an embodiment of the present disclosure.

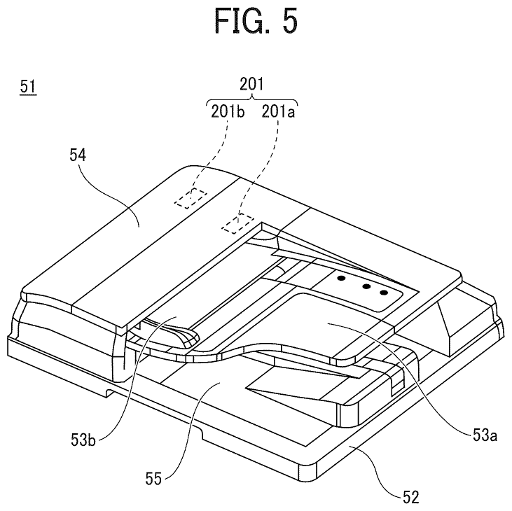

FIG. 5 is a perspective view of the ADF 51 according to an embodiment of the present disclosure.

FIG. 6 is a schematic diagram illustrating the configuration of the ADF 51 according to an embodiment of the present disclosure.

The ADF 51 is disposed above the scanner 150. As illustrated in FIGS. 4 to 6, the ADF 51 includes a document stacker 53a on which the document MS before reading is placed, and a document conveyor 54 that conveys the original document MS placed on the document stacker 53a along the document conveyance path 203. The document stacker 53a may be a document loading table.

The ADF 51 may include a document stacking table 55 for stacking the original documents MS after reading. The ADF 51 may include, specifically, a body cover 52. The body cover 52 may include the document stacker 53a and the document conveyor 54.

As illustrated in FIG. 4, the ADF 51 is openably supported by hinges 159 each being fixed to the scanner 150. The ADF 51 rotatably opens and closes in the upward and downward directions. With the rotation of the ADF 51 in the upward and downward directions, the ADF 51 works as an opening door, so that the first exposure glass 154 and the second exposure glass 155 on the upper face of the scanner 150 are exposed while the ADF 51 is open. In a case of the one-sided bound documents such as a book of a document bundle bounded on one-side, the original documents MS are not separated one by one. For this reason, the original documents MS in the above-described form are not conveyed by the ADF 51.

When reading the one-sided bound documents, the ADF 51 is opened as illustrated in FIG. 4. After the ADF 51 is opened as illustrated in FIG. 4, the one-sided bound documents are placed on the second exposure glass 155 with a page to be read facing down. Then, the ADF 51 is closed. Then, the scanner 150 causes the movable reading unit 152 to read the image on the page of the one-sided bound documents placed facedown.

On the other hand, when the original documents MS are in a form of a document bundle of simply accumulated individual original documents MS, the original documents MS are sequentially read by the first fixed reading unit 151 in the scanner 150 or the second fixed reading unit 95 in the ADF 51 while the ADF 51 automatically conveys the original documents MS one by one. In this case, a copy start button 158 is pressed after the bundle of original documents is placed on the document stacker 53a of the ADF 51. Then, the ADF 51 starts conveyance of the original documents MS that are a bundle of original documents stacked on the document stacker 53a to convey the original documents MS sequentially from top of the bundle of original documents MS to the document conveyor 54, and further convey the original documents MS to the document stacking table 55 while reversing the original document MS. In the course of this conveyance of the original documents MS, immediately after the original document MS is reversed, the original document MS is caused to pass immediately above the first fixed reading unit 151 of the scanner 150. At this time, the image on the first face of the original document MS is read by the first fixed reading unit 151 of the scanner 150.

As illustrated in FIG. 6, the ADF 51 according to the present embodiment includes a document setting part A, a document separating and feeding part B, a registration part C, a document turning part D, a first reading and conveying part E, a second reading and conveying part F, a document ejecting part G, and a document stacking part H. Further, the ADF51 includes a document conveyance path 203 for conveying the original document MS from the document stacker 53a toward the first fixed reading unit 151 that is an image reading position. In other words, the document conveyor 54 includes the document setting part A, the document separating and feeding part B, the registration part C, the document turning part D, the first reading and conveying part E, the second reading and conveying part F, the document ejecting part G, and the document conveyance path 203.

The document setting part A has the document stacker 53a on which a bundle of original documents MS is placed. The document separating and feeding part B separates and feeds the original document MS one by one from the bundle of the original documents MS set on the document stacker 53a. In the registration part C, the original document MS fed from the document separating and conveying part B temporarily contacts a pullout drive roller 86 and a pullout driven roller 87 to be aligned and fed again. The document turning part D has a conveyance passage curved in a C-shape, and turns the original document MS to be conveyed in the curved conveyance passage so as to reverse the original document MS upside down while turning the original document MS.

Then, in the first reading and conveying part E, the first fixed reading unit 151 disposed in the scanner 150 below the first exposure glass 154 as illustrated in FIG. 1 reads the first face of the original document MS while the original document MS is being conveyed on the first exposure glass 154. Further, in the second reading and conveying part F, the second fixed reading unit 95 reads the second face of the original document MS while the original document MS is conveyed under the second fixed reading unit 95. After the images on both sides of the original document MS are read, the original document MS is conveyed in the document ejecting part G to be ejected toward the document stacking part H. In the document stacking part H, the original documents MS are placed and stacked on the document stacking table 55.

The original document MS is placed on the movable document table 53b in the document setting part A, with the leading end of the original document MS placed on the movable document table 53b that is pivotable in the direction indicated by arrows “a” and “b” in FIG. 6 depending on the thicknesses of a bundle of the original documents MS and the trailing end of the original document MS placed on the document stacker 53a. At this time, the side guides of the document stacker 53a contact both lateral side ends of the original document MS in the width direction (i.e., the direction orthogonal to the drawing sheet) to adjust the position of the original document MS in the width direction. The original documents MS thus set push up a lever 62 that is pivotably disposed above the movable document table 53b. Along with this movement of the original documents MS, the document set sensor 63 detects the setting of the original documents MS, and transmits the detection signal to the ADF controller 904 (see FIG. 25). The detection signal is then transmitted from the ADF controller 904 to a scanner controller 903 (see FIG. 25) of the scanner 150 via an interface (I/F).

The first length sensor 57 and the second length sensor 58 are held on the document stacker 53a. Each of the first length sensor 57 and the second length sensor 58 includes a reflective photosensor or an actuator-type sensor for detecting the length of the original document MS in the sheet conveyance direction. The length of the original document MS in the sheet conveyance direction is detected with the first length sensor 57 and the second length sensor 58.

The pickup roller 80 is supported by the cam mechanism to be movable in the vertical direction (i.e., the directions indicated by arrows “c” and “d” in FIG. 6) and is disposed above the bundle of original documents MS placed on the movable document table 53b. The cam mechanism is driven by a pickup motor to move the pickup roller 80 in the vertical direction. As the pickup roller 80 moves upward, the movable document table 53b rotates in the direction indicated by arrow “a” in FIG. 6, so that the pickup roller 80 is brought to contact the uppermost original document MS placed on top of the bundle of original documents MS. As the movable document table 53b further moves upward, a table lifting sensor 59 detects that the movable document table 53b moves up to the maximum height. In response to this detection, the pickup motor stops driving to stop the movable document table 53b from moving up.

The apparatus control panel including, for example, a numeric keypad and a display included in the image forming apparatus 100 is operated by an operator to perform a key operation for setting a reading mode indicating a double-sided reading mode or a single-sided reading mode and a pressing operation of a copy start key. As the copy start button 158 is pressed by an operator, the document feeding signal is sent from a device controller 901 of the image forming device 1 to the ADF controller 904 of the ADF 51. In response to the document feeding signal, the pickup roller 80 is rotated along with the forward rotation of the sheet feeding motor 191, so that the original documents MS on the movable document table 53b are fed from the movable document table 53b.

The setting of the double-sided reading mode or the single-sided reading mode collectively covers the whole original documents MS stacked on the movable document table 53b. To be more specific, when the double-sided reading mode or the single-sided reading mode is set, both sides or a single-side of the whole original documents MS stacked on the movable document table 53b can be read.

In addition, individual reading mode setting can be performed on separate ones of the original documents MS. For example, the double-sided reading mode can be applied to the first and 10th original documents MS while the single-sided reading mode can be applied to the other original documents MS.

The original document MS fed by the pickup roller 80 enters the document separating and feeding part B to be fed to the contact position with the sheet feed belt 84. The sheet feed belt 84 is wound and stretched by, for example, a drive roller 82 to be endlessly moved in the clockwise direction in FIG. 5 by rotation of the drive roller 82 along with the forward rotation of the sheet feeding motor 191. A separation roller 85 is in contact with the lower stretched face of the sheet feed belt 84 to be rotated in the clockwise direction in FIG. 5 along with the forward rotation of the sheet feeding motor 191. At the contact portion, the sheet feed belt 84 is rotated so that the surface of the sheet feed belt 84 moves in the sheet conveyance direction. By contrast, the separation roller 85 is in contact with the sheet feed belt 84 with a given pressure. When the separation roller 85 directly contacts the sheet feed belt 84 or a single original document MS is nipped in the contact portion, the separation roller 85 is rotated with rotation of the sheet feed belt 84 or movement of the original document MS.

However, when multiple original documents MS are nipped in the contact portion, the force of the separation roller 85 to be rotated with rotation of the sheet feed belt 84 or movement of the original document MS is lower than the torque of a torque limiter. For this reason, the separation roller 85 is rotated in the clockwise direction that is opposite to a direction in which the separation roller 85 is rotated. As a result, the separation roller 85 applies the force of movement in the direction opposite to the sheet conveyance direction, to the original documents MS under the uppermost original document MS, so that the uppermost original document MS along is separated from the multiple original documents MS under the uppermost original document MS. The above-described operation is referred to as a sheet feeding and separating operation.

The original document MS is separated from the other original documents MS through the operations of the sheet feed belt 84 and the separation roller 85, and enters the registration part C. Then, the leading end of the original document MS is detected when the original document MS passes directly under a document contact sensor 72. At this time, the pickup roller 80 receiving the driving force of the pickup motor is still rotating. However, as the pickup roller 80 is separated from the original document MS due to descendance of the movable document table 53b, the original document MS is conveyed only by an endless moving force of the sheet feed belt 84. Then, the endless movement of the sheet feed belt 84 is continued for a given time from the timing at which the leading end of the original document MS is detected by the document contact sensor 72. Then, the leading end of the original document MS contacts the contact portion of the pullout driven roller 87 and the pullout drive roller 86 that rotates while contacting the pullout drive roller 86.

The pullout driven roller 87 has a function of conveying the original document MS to the intermediate roller pair 66 downstream from the pullout driven roller 87 in the document conveyance direction, and is driven and rotated by the rotation of the sheet feeding motor 191 in the reverse direction. As the sheet feeding motor 191 rotates in the reverse direction, the pullout driven roller 87 and one roller of the intermediate roller pair 66 contacting the pullout driven roller 87 start rotating and the endless movement of the sheet feed belt 84 stops. At this time, the pickup roller 80 also stops rotating.

The original document MS that is fed by the pullout driven roller 87 passes directly under the document width sensor 73. The document width sensor 73 includes multiple document detectors each including a reflective photosensor. The multiple document detectors are aligned in a row in the width direction of the original document MS (i.e., the direction perpendicular to the drawing sheet of FIG. 6). The size of the original document MS in the width direction is detected based on which one of the multiple document detectors detects the original document MS. The length of the original document MS in the document conveyance direction is detected based on the time from when the leading end of the original document MS is detected by the document contact sensor 72 to when the trailing end of the original document MS is not detected by the document contact sensor 72.

The leading end of the original document MS whose size in the width direction is detected by the document width sensor 73 enters the document turning part D and is nipped by the contact portion between the rollers of the intermediate roller pair 66. The conveyance speed of the original document MS conveyed by the intermediate roller pair 66 is set faster than the conveyance speed of the original document MS in the first reading and conveying part E that will be described below. This configuration achieves a reduction in time for conveying the original document MS to the first reading and conveying part E.

The leading end of the original document MS conveyed in the document turning part D passes through a position where the leading end of the original document MS faces the scan entrance sensor 67. As a result, when the leading end of the original document MS is detected by the scan entrance sensor 67, the document conveyance speed of the original document MS by the intermediate roller pair 66 is reduced until the leading end of the original document MS is conveyed to the position of the scan entrance roller pair (including rollers 89 and 90) downstream from the scan entrance sensor 67 in the sheet conveyance direction. As a document reading motor starts to drive and rotate, one roller of the scan entrance roller pair (including the rollers 89 and 90), one roller of a first scan exit roller pair 92, and one roller of a second scan exit roller pair 93 respectively start rotation.

In the document turning part D, while the original document MS is conveyed in the curved conveyance passage between the intermediate roller pair 66 and the scan entrance roller pair (including the rollers 89 and 90), the upper and lower faces of the original document MS are reversed, and the conveyance direction of the original document MS is turned back. Then, the leading end of the original document MS that has passed through the nip region between the rollers (89 and 90) of the scan entrance roller pair passes directly under the registration sensor 65. The operation up to this point after the sheet feeding and separating operation is referred to as a “document pullout operation”.

When the registration sensor 65 detects the leading end of the original document MS, the conveyance speed of the original document MS is gradually decreased through the given conveyance distance. Then, the rotation of the pullout drive roller 86 and the intermediate roller pair 66 is stopped due to the stop of the sheet conveyance motor 192, which will be described below, and the rotation of the scan entrance roller pair is stopped due to the stop of the document reading motor. Due to this action, the conveyance of the original document MS is temporarily stopped at the registration position before the first reading and conveying part E. Further, a registration stop signal is sent to the scanner controller 903 of the scanner 150.

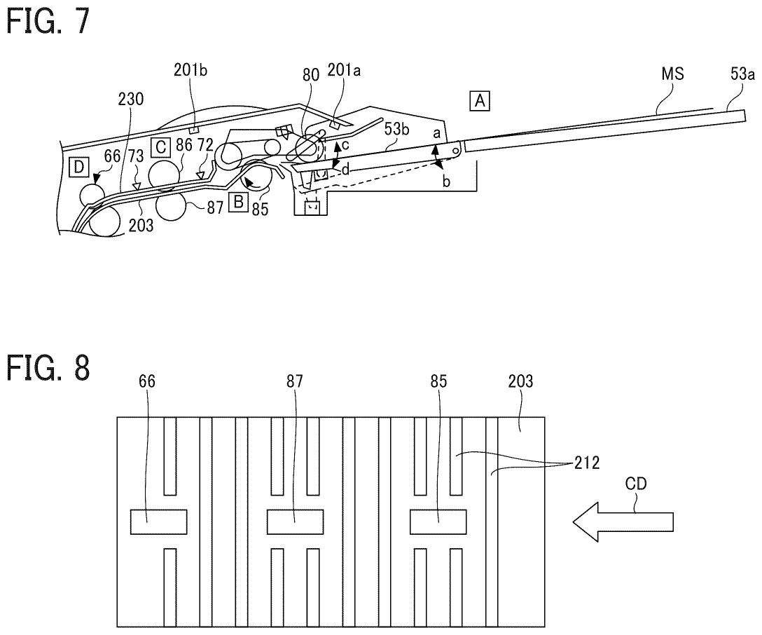

FIG. 7 is a partially enlarged view of the main part of the ADF 51 of FIG. 5.

FIG. 8 is a top view of a part of the document conveyance path 203 of the ADF 51 according to an embodiment of the present disclosure.

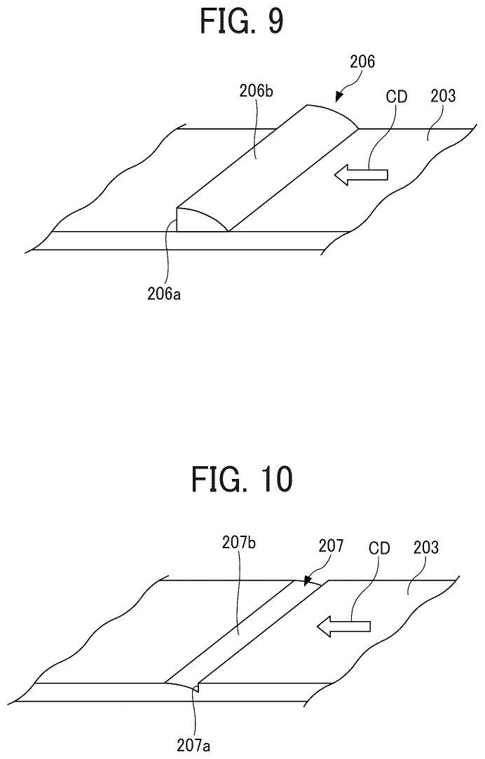

FIG. 9 is a perspective view of the sound generators 212 according to an embodiment of the present disclosure.

FIG. 10 is a perspective view of the sound generator 212 according to a first modification of the sound generators 212 of an embodiment of the present disclosure.

As illustrated in FIGS. 7 to 10, the ADF 51 includes one or more sound generators 212 on the document conveyance path 203 and having a protrusion or a recess with respect to the surface of the document conveyance path 203, and sound collectors 201 that perform sound collection when any one of the sound generators 212 and a fastening object attached to the original document MS come into contact with each other.” The sound collection indicates collecting sound.

As illustrated in FIG. 8, the sound generators 212 are continuously or intermittently disposed from one end to the other end in the width direction of the document conveyance path 203. When the original document MS with a fastening object such as a clip or a stapler is conveyed to the document conveyance path 203, the sound generators 212 and the fastening object come into contact with each other, and abnormal sound different from normal operation sound such as a sound of collision or a sound of rubbing when the fastening object rides over the sound generators 212 is generated. The noise generated by the fastening object is referred to as “abnormal sound”. Since the sound generators 212 are disposed over the entire width direction of the document conveyance path 203, the fastening object and the sound generators 212 can be brought into contact with each other to generate an abnormal sound regardless of the position of the fastening object in the width direction of the document conveyance path 203.

The ADF 51 includes a prediction unit 202 that predicts whether any fastening object is attached to an original document MS or not, based on the sound collected by the sound collectors 201. When any of the sound generators 212 and the fastening object come into contact with each other, the abnormal sound is mixed with the operation sound collected by the sound collectors 201, and the operation sound becomes a characteristic operation sound, which can be distinguished from the operation sound during normal conveyance. For this reason, the prediction unit 202 can predict the presence or absence of the fastening object based on the sound collected by the sound collectors 201.

As described above, the fastening object attached to the original document MS can be detected by the ADF 51.

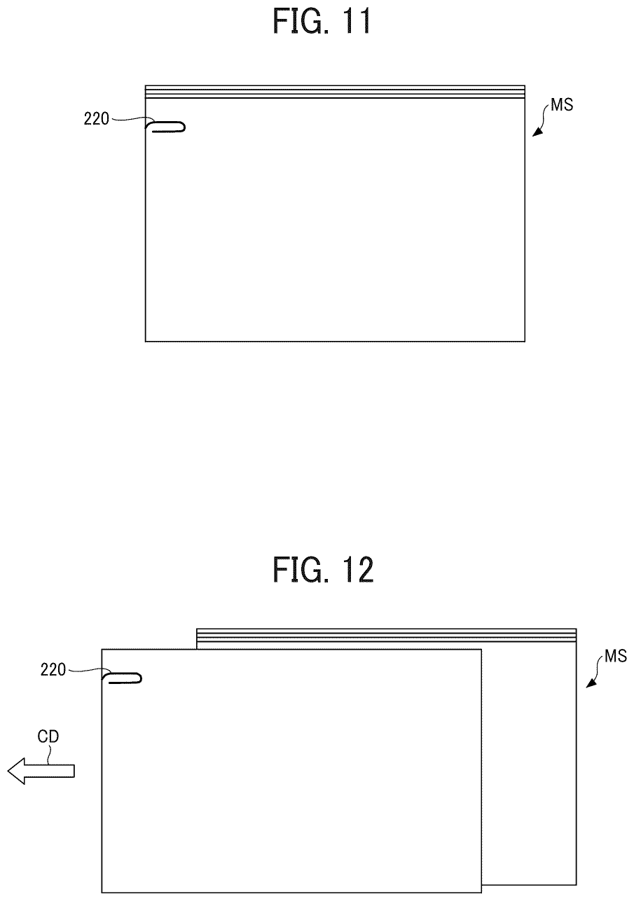

FIG. 11 is a schematic diagram illustrating an example of the original document MS to which a fastening object 220 is attached.

FIG. 12 is a diagram illustrating conveyance of the original document MS of FIG. 11.

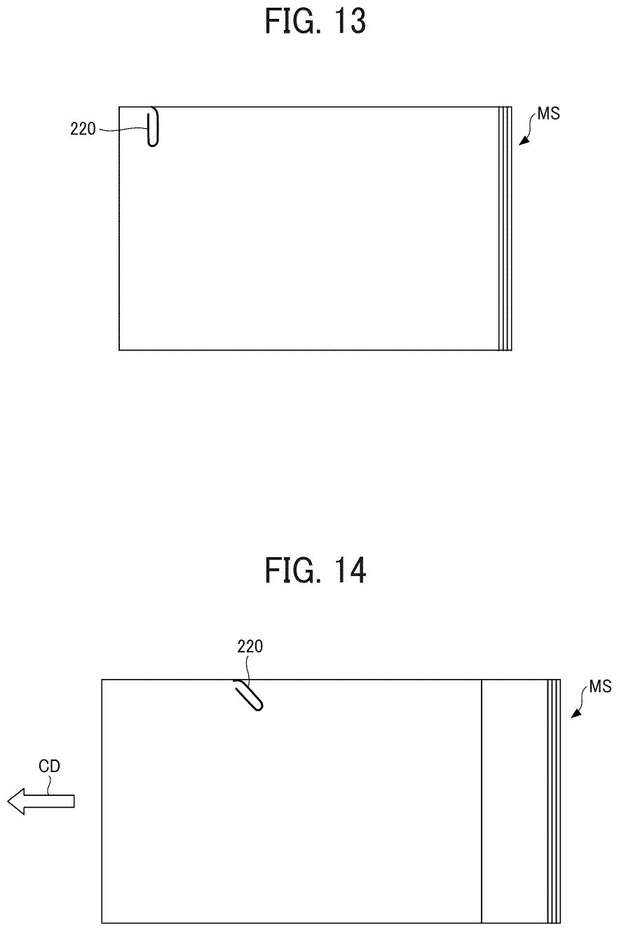

FIG. 13 is a schematic diagram illustrating another example of the original document MS to which the fastening object 220 is attached.

FIG. 14 is a diagram illustrating conveyance of the original document MS of FIG. 13.

In the example illustrated in FIGS. 11 and 12, the uppermost document MS is conveyed to the document conveyance path 203 while the fastening object 220 is attached to the original document MS. In such a case, when the fastening object 220 contacts any part of the document conveyance path 203, the conveyance of the original document MS is stopped, which leads to occurrence of a jam.

In the example illustrated in FIGS. 13 and 14, it is conceivable that the fastening object 220 remains at the place together with the document bundle, and the uppermost document MS is pulled out and further conveyed. However, in either case, any one of the original documents MS in the document bundle is finally conveyed together with the fastening object 220. Since the fastening object 220 is attached to the side face in the document conveyance direction, when the fastening object 220 comes into contact with any part of the document conveyance path 203 during the conveyance of the original document MS, the fastening object 220 is removed from the original document MS and falls onto the document conveyance path 203. If the subsequent original document is conveyed when the fastening object 220 remains on the document conveyance path 203, the subsequent original document collides with the fastening object 220 dropped on the document conveyance path 203, which also causes a jam.

With the ADF 51 according to the present embodiment, in the cases as illustrated in FIGS. 11 to 14, in other words, regardless of the position where the fastening object passes in the document conveyance path 203, whether the fastening object is attached to the original document MS can be predicted and the fastening object can be detected.

A description is given of the sound generator 206 having a protrusion on the surface of the document conveyance path 203.

As illustrated in FIG. 9, the sound generator 206 includes a first face 206a and a sloped face 206b. The first face 206a extends from the surface of the document conveyance path 203 upward in the vertical direction. The sloped face 206b couples to the upper end of the first face 206a and the surface of the document conveyance path 203. The sloped face 206b extends from the upper end of the first face 206a in the opposite direction from the conveyance direction CD. In other words, the sloped face 206b is disposed to contact the leading end of the original document MS that is under conveyance. The first face 206a is a face along in the width direction of the document conveyance path 203.

A description is given of the sound generator 207 having a recess in the surface of the document conveyance path 203.

As illustrated in FIG. 10, the sound generator 207 includes a first face 207a and a sloped face 207b. The first face 207a extends from the surface of the document conveyance path 203 downward in the vertical direction. The sloped face 207b couples to the lower end of the first face 207a and the surface of the document conveyance path 203. The sloped face 207b extends from the lower end of the first face 207a in the conveyance direction CD. In other words, the sloped face 207b is disposed to contact the leading end of the original document MS that is under conveyance. The sound generator 207 may be a groove formed in the surface of the document conveyance path 203. The first face 207a is a face along in the width direction of the document conveyance path 203.

As described above, the sound generators 212 include the first faces 206a and 207a extending from the surface of the document conveyance path 203 in the vertical direction, and the sloped faces 206b and 207b extending from the ends of the first faces 206a and 207a to the surface of the document conveyance path 203 in the vertical direction. It is preferable that the multiple sound generators 212 are disposed at intervals in the conveyance direction CD of the original document MS. With this configuration, the ADF 51 can increase the volume of the abnormal sound and the chances of occurrence of abnormal sound, and can enhance the detection accuracy of a fastening object.

Since the sound generators 212 have the sloped faces 206b and 207b as described above, the original document MS can be conveyed along the sloped faces 206b and 207b. For this reason, even if there is a recess or a protrusion on the document conveyance path 203 due to the sound generators 212, the ADF 51 restrains or prevents conveyance of the original document MS from being hindered by the recess or the protrusion, and can prevent the original document MS from being damaged.

As illustrated in FIG. 8, the document conveyance path 203 is provided with the separation roller 85, the pullout driven roller 87, and the intermediate roller pair 66, in this order from the upstream side in the conveyance direction CD. In FIG. 8, a curved portion between the separation roller 85 and the pullout driven roller 87 on the conveyance path is omitted. Specifically, the sound generators 212 may be disposed on both sides in the width direction of the document conveyance path 203, interposing the separation roller 85, the pullout driven roller 87, and the intermediate roller pair 66. In addition, in a region where the separation roller 85, the pullout driven roller 87, and the intermediate roller pair 66 are not disposed in the width direction of the document conveyance path 203, the sound generators 212 may be disposed so as to extend from one end to the other end in the width direction of the document conveyance path 203.

It is preferable that the sound generators 212 are disposed upstream from the downstream end of the intermediate roller pair 66 in the conveyance direction CD. As illustrated in FIG. 6, the document conveyance path 203 has a largely curved portion on the downstream side from intermediate roller pair 66 in the conveyance direction CD. When the original document MS with the fastening object attached enters the document conveyance path 203 downstream from the intermediate roller pair 66 in the conveyance direction CD, the fastening object does not pass the largely curved portion and a jam occurs. This may cause a significantly damage on the original document MS, for example, the original document MS may be wrinkled in a bellows shape. Further, in the document conveyance path 203 downstream from the intermediate roller pair 66 in the conveyance direction CD, when the fastening object comes off from the original document MS, the fastening object may fall down from the document conveyance path 203, which makes the removal of the fastening object difficult.

Accordingly, with the ADF 51 provided with the sound generators 212 upstream from the downstream end of the intermediate roller pair 66 in the conveyance direction CD, whether the fastening object is attached to the original document MS can be predicted before the original document MS reaches the intermediate roller pair 66, and the damage on the original document MS can be prevented.

The sound collectors 201 may be sound collection microphones. The sound collectors 201 are attached to the sheet feeder cover 98, and may be disposed at least above the document conveyance path 203. The sound collectors 201 may be disposed, for example, on the back of the sheet feeder cover 98 of the ADF 51.

As illustrated in FIGS. 5 to 7, the sound collectors 201 may include a first sound collector 201a and a second sound collector 201b. The first sound collector 201a is disposed on the back face of the sheet feeder cover 98 upstream from the pickup roller 80 in the conveyance direction CD. The second sound collector 201b is disposed on the back face of the sheet feeder cover 98 downstream from the drive roller 82 and upstream from the sheet feeder cover 98 from the pullout drive roller 86 in the conveyance direction CD. The number of sound collectors 201 may be one or more. The positions of the sound collectors 201 are not limited to the positions illustrated in FIGS. 5 to 7.

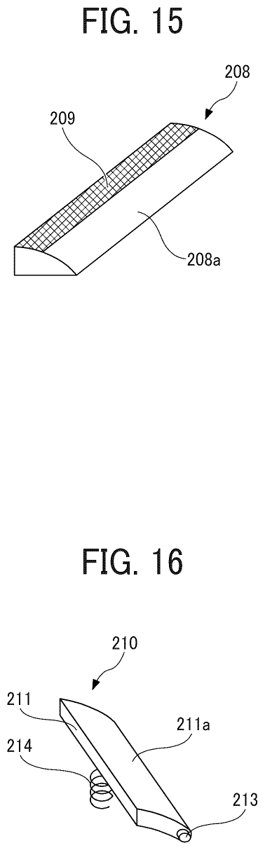

FIG. 15 is a perspective view of a sound generator according to a second modification of the sound generators 212 of an embodiment of the present disclosure.

As illustrated in FIG. 15, a sound generator 208 may include a contact face 208a with the original document MS, and a cutout portion 209 in the contact face 208a or a rough face portion having the surface roughness greater than the surface roughness of the document conveyance path 203. The surface roughness may be, for example, an arithmetic average roughness (Ra).

Due to such a configuration, in addition to the sound generated when the fastening object collides with the contact face 208a, abnormal sound is generated as the fastening object rubs against the contact face 208a when the fastening object moves on the contact face 208a. With this configuration, the ADF 51 can increase the chances of occurrence of abnormal sound, and can enhance the detection accuracy of a fastening object. In the example illustrated in FIG. 15, the sound generator 208 has a protrusion on the surface of the document conveyance path 203. However, the same effect is achieved even in a case where the sound generator 207 having a recess has a cut portion or a rough face portion on the sloped face 207b that is the contact face with the original document MS, as in the example illustrated in FIG. 10.

FIG. 16 is a perspective view of a sound generators according to a third modification of the sound generators 212 of an embodiment of the present disclosure.

In a case where a sound generator 210 has a protrusion on the surface of the document conveyance path 203, as illustrated in FIG. 16, the sound generator 210 may include a plate member 211, a protrusion 213, and an elastic member 214. The plate member 211 includes a sloped face 211a. The protrusion 213 is disposed on the side face of the plate member 211. The elastic member 214 supports the plate member 211 to be movable in a direction orthogonal to the surface of the document conveyance path 203. The protrusion 213 may be fixed to, for example, ribs 204 (described below) formed on the document conveyance path 203. The plate member 211 is rotatable about the protrusion 213.

Since the sound generator 210 having the protrusion on the surface of the document conveyance path 203 includes the plate member 211 and the elastic member 214, when the fastening object passes on the plate member 211, the plate member 211 is lowered. Then, when the fastening object passed the plate member 211, the plate member 211 is bounced back upward by the elastic member 214. At this time, abnormal sound (noise) such as sound generated by the plate member 211 or the elastic member 214 or sound generated when the plate member 211 comes into contact with the original document MS being conveyed is generated. With this configuration, the ADF 51 can increase the chances of occurrence of abnormal sound (noise), and can enhance the detection accuracy of a fastening object.

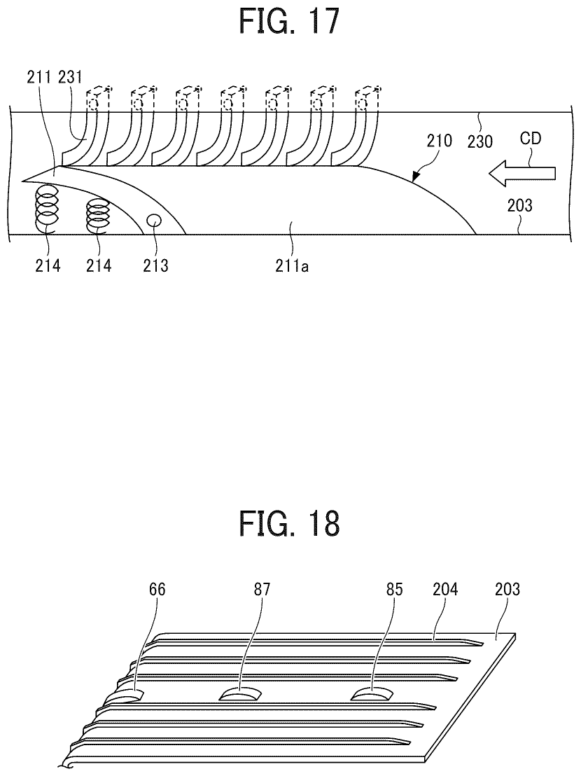

FIG. 17 is a perspective view of a sound generator according to a fourth modification of the sound generators 212 of an embodiment of the present disclosure.

The sound generator 210 may include, in addition to the configuration of FIG. 16, an opposing member 231 disposed above the plate member 211 so as to face the plate member 211. With this configuration, when the plate member 211 is bounced back upward by the elastic member 214, a portion of the sloped face 211a of the plate member 211, which is located outside the original document MS in the widthwise direction, collides with the opposing member 231. By so doing, the volume of the generated abnormal sound increases. Accordingly, the ADF 51 can enhance the detection accuracy of the fastening object.

The opposing member 231 is rotatably fixed to a top board 230 disposed facing the upper part of the document conveyance path 203. One end of the opposing member 231 is fixed to the top board 230 and extends toward the plate member 211. In other words, the opposing member 231 is suspended from the top board 230 and the other end of the opposing member 231 is movable. The other end of the opposing member 231 is movable along, for example, the conveyance direction CD. Multiple opposing members 231 may be disposed along the width direction of the document conveyance path 203. The opposing member 231 may have a shape in which a portion on the other end is curved so as to extend toward the downstream side in the conveyance direction CD. The other end of the opposing member 231 is in contact with the plate member 211. Multiple elastic members 214 may be disposed on the document conveyance path 203.

The material of the opposing member 231 may be a metal. With this configuration, the material of the opposing member is metallic. Since the material of the opposing member is metallic, the portion of the sloped face 211a of the plate member 211 located outside the original document MS in the widthwise direction collides with the opposing member, which can generate the sound having a different frequency from the operation sound. Accordingly, the ADF 51 can enhance the detection accuracy of the fastening object.

FIG. 18 is a top view of a part of the document conveyance path 203 according to the first modification of an embodiment of the present disclosure.

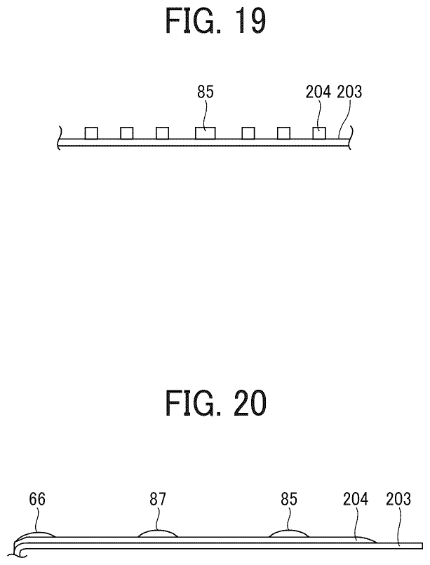

FIG. 19 is a diagram illustrating the part of the document conveyance path 203 of FIG. 18, viewed from the upstream side in the conveyance direction CD.

FIG. 20 is a side view of the part of the document conveyance path 203 of FIG. 18.

As illustrated in FIGS. 18 to 20, the ADF 51 may include the rib 204 on the document conveyance path 203 and extend in the conveyance direction CD of the original document MS. The ribs 204 have a function of reducing a frictional force when the rib 204 comes into contact with the original document MS during the conveyance of the original document MS.

Multiple ribs 204 may be disposed at intervals in the width direction of the document conveyance path 203.

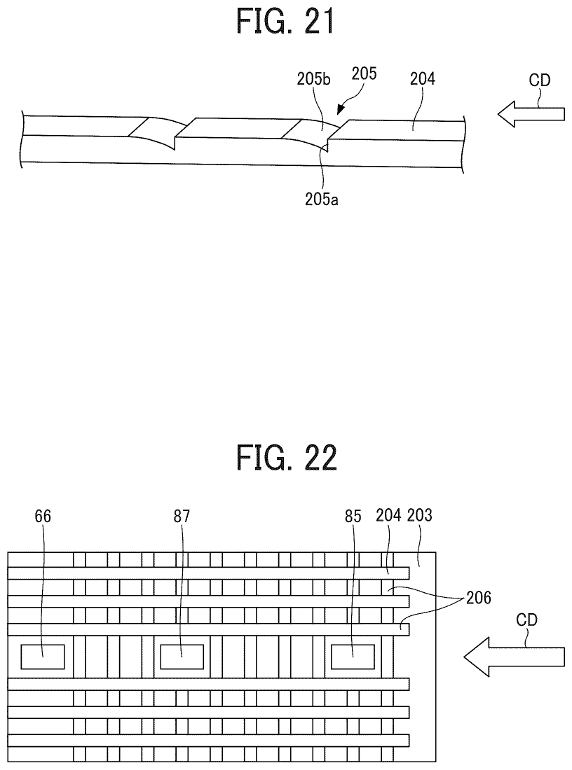

FIG. 21 is a perspective view of a sound generator according to a fifth modification of the sound generators 212 of an embodiment of the present disclosure.

As illustrated in FIG. 21, one or more sound generators 205 may be disposed on the rib 204. The sound generator 205 has recesses in the surface of the document conveyance path 203. When the ADF 51 has the rib 204 or the ribs 204, it is difficult to dispose the sound generators 212 having the protrusion from one end to the other end in the width direction of the document conveyance path 203. With the sound generator 205 having the recesses in the surface of the rib 204, abnormal sound is generated when a fastening object passes on the rib 204. Accordingly, the ADF 51 can detect the fastening object.

As illustrated in FIG. 21, the sound generator 205 includes a first face 205a and a sloped face 205b. The first face 205a extends from the surface of the rib 204 downward in the vertical direction. The sloped face 205b couples to the lower end of the first face 207a and the upper face of the rib 204. The sloped face 205b extends from the lower end of the first face 205a in the conveyance direction CD. In other words, the sloped face 205b is disposed to contact the leading end of the original document MS that is under conveyance. The sound generator 205 may be a groove formed in the upper face of the rib 204. The first face 205a is a face along the width direction of the document conveyance path 203. The sound generator 205 may be disposed on each of the multiple ribs 204 and arranged on the same straight line in the width direction of the document conveyance path 203.

FIG. 22 is a top view of a part of the document conveyance path 203 according to the second modification of an embodiment of the present disclosure.

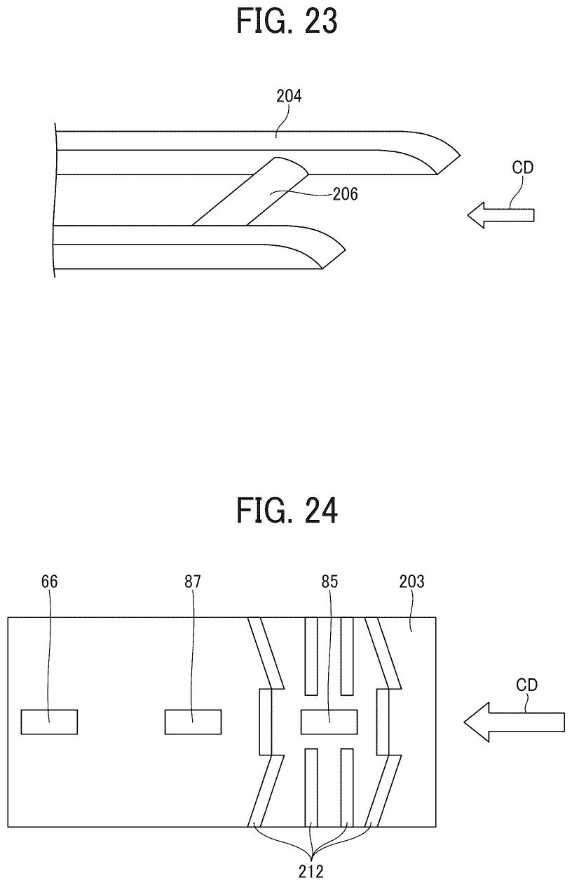

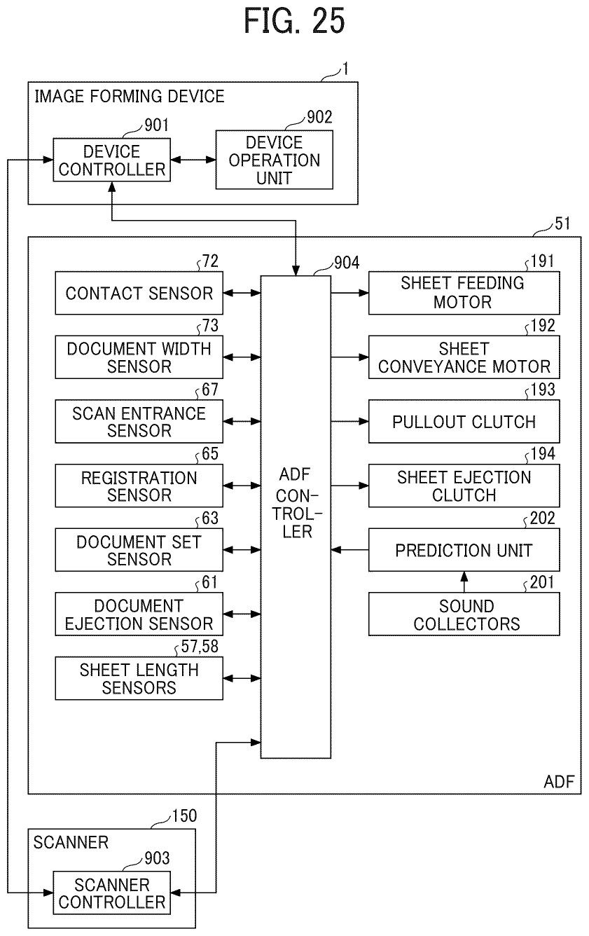

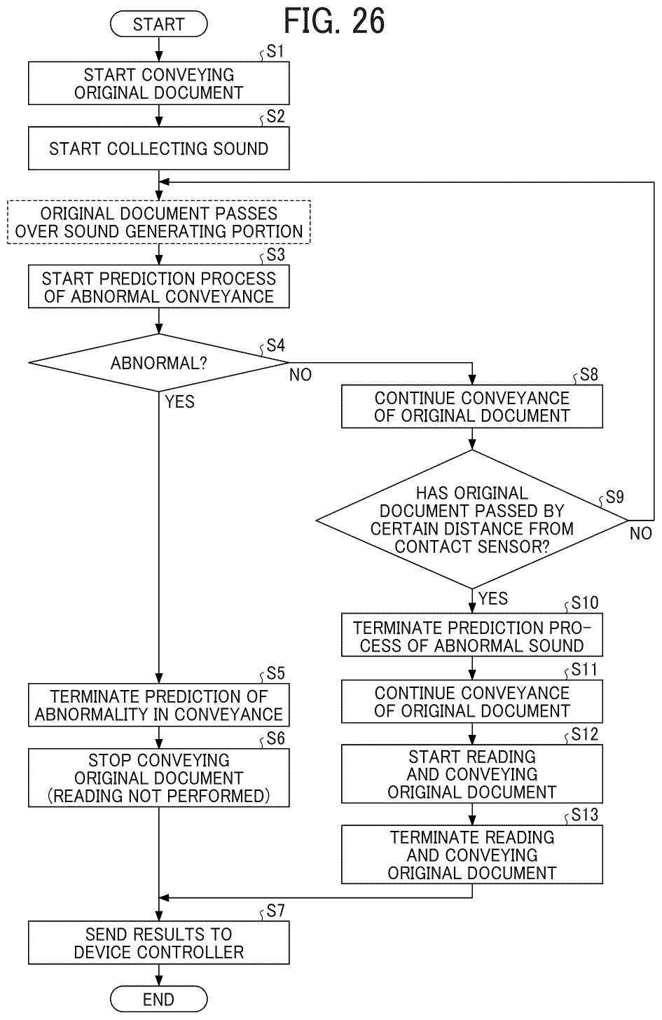

FIG. 23 is an enlarged perspective view of a part of the document conveyance path 203 of FIG. 22.

When the multiple ribs 204 are disposed spaced apart from each other in the width direction of the document conveyance path 203, the multiple sound generators 212 may have a protrusion on the document conveyance path 203 and be disposed to fill the spaces between the adjacent ribs 204 in the width direction of the document conveyance path 203, as illustrated in FIGS. 22 and 23. Further, the height of the sound generators 212 on the surface of the document conveyance path 203 is preferably lower than the height of the ribs 204 on the surface of the document conveyance path 203.

When the height of the sound generators 212 on the surface of the document conveyance path 203 is equal to or greater than the height of the ribs 204 on the surface of the document conveyance path 203, the original document MS is conveyed while contacting the sound generators 212. Due to such a configuration, the original document MS may be damaged. Since the height of the sound generators 212 on the surface of the document conveyance path 203 is lower than the height of the ribs 204 on the surface of the document conveyance path 203, the probability that the original document MS contacts the sound generators 212 can be reduced, and damage on the original document MS can be restrained or prevented. In addition, since the probability that the original document MS contacts the sound generators 212 is reduced, it is easier to detect abnormal sound generated when the fastening object contacts the sound generators 212. Accordingly, the ADF 51 can enhance the detection accuracy of the fastening object.

The difference between the height of the sound generators 212 on the surface of the document conveyance path 203 and the height of the ribs 204 on the surface of the document conveyance path 203 can be set to be equal to or less than, for example, the thickness of the fastening object.

In the example illustrated in FIGS. 22 and 23, the upper face of the ribs 204 is a flat face. However, the configuration is not limited to the above-described configuration. For example, the sound generator 205 illustrated in FIG. 21 may be disposed on the upper face of the ribs 204. This configuration can increase the abnormal sound generated when the fastening object contacts the sound generators 212.

FIG. 24 is a top view of a part of the document conveyance path 203 of the ADF 51 according to another example of an embodiment of the present disclosure.

As illustrated in FIG. 24, the multiple sound generators 212 may be arranged at different intervals in the conveyance direction CD of the original document MS. With this configuration, when the fastening object passes over the sound generators 212, a sound, particularly a collision sound, irregularly, can be generated, a sound of a specific rhythm can be generated. With this configuration, the prediction unit 202 can predict whether a fastening object is attached to the original document MS based on the specific rhythm, and the ADF 51 can enhance the detection accuracy of the fastening object.

Examples of the material of the surface of the sound generators 212 include, for example, resin and metal. The material of the surface of the sound generators 212 is preferably metal. Accordingly, when the fastening object includes metal, the frequency of the abnormal sound generated due to the contact of the fastening object and the sound generators 212 and the frequency of the normal operating sound increases. Accordingly, the ADF 51 can enhance the detection accuracy of the fastening object.

FIG. 25 is a block diagram illustrating a part of an electric circuit of the image forming apparatus 100 according to an embodiment of the present disclosure.

The electric circuit of the image forming apparatus 100 includes, for example, the device controller 901 of the image forming device 1, the scanner controller 903 of the scanner 150, and the ADF controller 904 of the ADF 51. These controllers (i.e., the device controller 901, the scanner controller 903, and the ADF controller 904) include, for example, a central processing unit (CPU), a random access memory (RAM), and a read-only memory (ROM). The device controller 901 and the scanner controller 903 are connected to communicate with each other. The scanner controller 903 and the ADF controller 904 are connected to communicate with each other. The ADF controller 904 and the device controller 901 are connected to communicate with each other.

The ADF controller 904 is connected to a registration sensor 65, a document set sensor 63, a document ejection sensor 61, the document contact sensor 72, a document width sensor 73, a scan entrance sensor 67, the first length sensor 57, and the second length sensor 58, as illustrated in FIG. 25. The ADF controller 904 is further connected to, for example, a sheet feeding motor 191, a sheet conveyance motor 192, a pullout clutch 193, a sheet ejection clutch 194, and a prediction unit 202. The sound collectors 201 are connected to the prediction unit 202.

The sheet conveyance motor 192 connected to the ADF controller 904 is a rotation drive source for the pullout drive roller 86 and the document ejection roller pair 94 in the ADF 51. The pullout clutch 193 connected to the ADF controller 904 connects and disconnects the rotation driving force of the sheet conveyance motor 192 to and from the pullout drive roller 86. Then, the sheet ejection clutch 194 connects and disconnects the rotation drive force of the sheet conveyance motor 192 to and from the document ejection roller pair 94 as a feeding and conveying device.

After receiving the registration stop signal from the ADF controller 904, the scanner controller 903 sends the reading start signal as a sheet feeding permission signal to the ADF controller 904. Then, the ADF controller 904 restarts rotating the sheet conveyance motor 192 and the document reading motor. Then, the timing at which the leading end of the original document MS reaches the reading position of the first fixed reading unit 151 is calculated based on the pulse counts of the document reading motor. At this timing, the ADF controller 904 sends a gate signal indicating an effective image area of the first face of the original document MS in the sub-scanning direction, to the scanner controller 903. The ADF controller 904 continues sending the gate signal to the scanner controller 903 until the trailing end of the original document MS passes through the reading position of the first fixed reading unit 151, so that the first face of the original document MS is scanned by the first fixed reading unit 151.

The original document MS that has passed through the first reading and conveying part E passes through the first scan exit roller pair 92, which will be described below. Then, the leading end of the original document MS is detected by the document ejection sensor 61. When the single-sided reading mode is set, the second face of the original document MS is not to be read by the second fixed reading unit 95, which will be described below. Then, when the leading end of the original document MS is detected by the document ejection sensor 61, the sheet ejection clutch 194 connects the driving force of the conveyance motor to the document ejection roller pair 94. The timing at which the trailing end of the original document MS passes through the nip region of the document ejection roller pair 94 is calculated based on the pulse counts of the document ejection motor after the detection of the leading end of the original document MS by the document ejection sensor 61. Then, based on this calculation result, the sheet ejection clutch 194 is stopped.

On the other hand, when the double-sided reading mode is set, the document ejection sensor 61 initially detects the leading end of the original document MS. Then, the timing of the period to which the original document MS reaches the second fixed reading unit 95 is calculated based on the pulse counts of the document reading motor. Then, at this timing, the ADF controller 904 sends a gate signal indicating the effective image area of the second face of the original document MS in the sub-scanning direction, to the scanner controller 903. The ADF controller 904 continues sending the gate signal to the scanner controller 903 until the trailing end of the original document MS passes through the reading position of the second fixed reading unit 95, so that the second face of the original document MS is scanned by the second fixed reading unit 95.

The second fixed reading unit 95 includes contact-type image sensors (CIS) and is coated on the reading face for the purpose of preventing reading vertical streaks due to the paste-like foreign substance adhering to the original document MS to adhere to the reading face of the second fixed reading unit 95. A second reading roller 96 as a document supporter that supports the original document MS from a non-reading face is disposed at a position facing the second fixed reading unit 95. The second reading roller 96 functions as a floating retainer that prevents the original document MS from floating up at the reading position by the second fixed reading unit 95 and as a reference white portion for acquiring in the shading data on the second fixed reading unit 95.

The prediction unit 202 can predict whether a fastening object is attached to the original document MS, using parameters acquired by performing machine learning in advance. The description of machine learning will be given below.

FIG. 26 is a flowchart of a fastening object determination process executed by the ADF controller 904 according to an embodiment of the present disclosure.

The ADF controller 904 separates the original documents MS one by one from the bundle of original documents MS set on the document stacker 53a in the document setting part A to feed the separated original document MS. Simultaneously, the ADF controller 904 executes the process following the flow of the flowchart illustrated in FIG. 26, on each of the original documents MS. In the present embodiment, the sheet feeding operation of the original documents MS is continuously performed with given intervals between adjacent original documents MS to such an extent that the original documents MS do not overlap with each other in order to increase the throughput of reading. For this reason, multiple original documents MS are simultaneously present at the intervals between adjacent original documents MS in the document conveyance path 203. Accordingly, the flow of the flowchart of FIG. 26 is executed in parallel with an interval for each of the original documents MS.

When the reading instruction is transmitted from the device controller 901 to the ADF controller 904, the ADF controller 904 starts the document conveyance operation (step S1). Simultaneously, the ADF controller 904 starts collecting the operation sound by the sound collectors 201 (step S2). Specifically, in step S1, the ADF controller 904 starts driving the pickup roller 80. Then, the original document MS enters the document conveyance path 203, and passes over the sound generators 212. When the original document MS has the fastening object, abnormal sound is generated. The prediction unit 202 acquires the collected operation sounds from the sound collectors 201, and starts the prediction process of abnormal conveyance, in other words, the prediction process of whether the fastening object is attached to the original document MS, based on the operation sound (step S3).

In step S3, the prediction process of whether a fastening object is attached to the original document MS is executed at a constant cycle. In step S3, the prediction unit 202 determines whether the original document MS is normally conveyed or abnormally conveyed (with or without a fastening object) using “parameters acquired in advance by machine learning”.

The “parameter obtained by machine learning in advance” can be generated as follows. The sound of the passing of the original document MS without the fastening object and the sound of the passing of the original document MS with the fastening object are recorded under various conditions, in other words, by varying the error factors. Then, the sound is labeled as “with fastening object” or “without fastening object” to be subjected to machine learning. The generated parameters correspond to a “trained model” in the description of machine learning to be described below.

A description is now given of an outline of machine learning.

Machine learning is one of methods for analyzing data, and is a method in which a computer (machine) performs “automatic learning” from datasets to find rules or patterns in the background of the datasets. The rules or patterns obtained as a result of learning is called a “trained model”. Prediction and determination can be performed by using this trained model obtained (learned) by machine learning in advance.

Examples of the machine learning include a Mahalanobis Taguchi (MT) method and a support vector machine. The following description is given of the MT method. The audio signals collected by the sound collectors 201 are temporarily stored in the RAM of the ADF controller 904. The short-time Fourier transform (STFT) is performed on the audio signals stored in the RAM of the ADF controller 904 by dividing a longer time signal into shorter segments of equal length (frame processing), and then computing the Fourier transform separately on each shorter segment. By so doing, the time sequence of the power spectrum of the audio signal can be calculated in real time. The ADF controller 904 then performs a characterization process sequentially on the time sequence of the calculated power spectrum to calculate the feature amount of the sound. The feature amount of the sound is also stored in the RAM of the ADF controller 904. The characterization process may include, for example, time integration of power in a given frequency band and spectral flux between successive frames.

Subsequently, the abnormality in conveyance is predicted by using the accumulated feature amount of the sound as an input. A method of predicting the abnormal conveyance is to use the Mahalanobis distance by the MT method. In the field of quality engineering, the MT method is one of Mahalanobis-Taguchi (MT) system known for prediction, diagnosis and analysis based on multidimensional information data. The MT system is a general term for methods for analyzing multidimensional information data, such as the MT method, the MTA method, the TS method, the T method (1), the T method (2), the RT method, and the mean-squared deviation method. The MT method is a method using the Mahalanobis distance, and is a simple and relatively accurate method in which the correlation between items is considered.

An inverse matrix R-1 of the correlation matrix of a unit space dataset used when calculating the Mahalanobis distance is stored in the ROM of the ADF controller 904. The inverse matrix R-1 of the correlation matrix is obtained in advance by creating a unit space dataset (i.e., reference dataset) based on a feature amount obtained from a sound signal by reading a normal original document MS under various erroneous factor conditions in the ADF 51, and is stored in the ROM of the ADF controller 904. The obtained unit space dataset corresponds to a “trained model”.

In a case where the Mahalanobis distance is equal to or smaller than the threshold value Th, it is determined that the conveyance is normal (without fastening object). On the other hand, in a case where the Mahalanobis distance is greater than the threshold value Th, it is determined that the conveyance is abnormal (with fastening object). The threshold value Th is set to a value that can be determined as normal with a margin with respect to a unit space dataset (i.e., a reference dataset) created under various erroneous factor conditions in the ADF 51. Accordingly, the threshold value Th is set so as to hardly cause false positives, instead of allowing false negatives to some extent. In step S3, the prediction process of whether a fastening object is attached to the original document MS is executed using the machine learning as described above.

The prediction unit 202 determines whether the conveyance is normal or abnormal (whether a fastening object is attached to the original document MS) (step S4). When the conveyance is abnormal (with fastening object) (YES in the step S4), the prediction process (prediction of abnormality in conveyance) is terminated (step S5). At this time, sound collection by the sound collectors 201 is also terminated. After step S5, the drive of the sheet feeding motor 191 is stopped, and the pickup roller 80 is elevated to stop the document conveying operation (step S6). At this point, the reading operation of the original document MS is not performed. After step S6, the ADF controller 904 transmits the result indicating that the conveyance is abnormal, to the device controller 901 (step S7).

When the device controller 901 receives the result indicating that there is abnormal conveyance from the ADF controller 904, the device controller 901 completes the reading instruction. The device controller 901 displays a message “Abnormal conveyance of original document is detected. Please check original document” on the display of the apparatus operation unit 902 with an abnormal conveyance alarm sound, and notifies the user of the conveyance state.

On the other hand, when the prediction unit 202 determines that the conveyance is normal (without fastening object) (No in step S4), the document conveyance operation is continued (step S8). After step S8, the ADF controller 904 determines whether the original document MS has passed by a certain distance from the document contact sensor 72 (step S9). The certain distance from the document contact sensor 72 may be, for example, a distance from the document contact sensor 72 to the intermediate roller pair 66. When the ADF controller 904 determines that the original document MS has passed by a certain distance from the document contact sensor 72 (YES in step S9), the prediction process of abnormal conveyance ends (step S10). At this time, sound collection by the sound collectors 201 is also terminated.

After step S10, the ADF controller 904 continues the document conveyance operation (step S11), and starts the process for reading and conveying the original document MS (step S12). In addition, between step S11 and step S12, the process of detecting abnormal conveyance may be performed by another sensor that is provided in the related art. After step S12, the process for reading and conveying the original document MS is terminated (step 13).

After step S13, the ADF controller 904 transmits a result indicating that there is no abnormal conveyance, to the device controller 901 (step S7). As the device controller 901 receives the result indicating that there is no abnormal conveyance, from the ADF controller 904, the device controller 901 completes the reading instruction.

When the ADF controller 904 determines that the original document MS has not passed a certain distance from the document contact sensor 72 (NO in step S9), the process goes back to step S4 and the prediction unit 202 determines again whether there is any abnormal conveyance (whether there is a fastening object attached to the original document MS).

The image forming apparatus 100 according to the present embodiment includes an automatic document feeder 51 and an image forming device 1. With this configuration, the image forming apparatus 100 includes the automatic document feeder 51, and thus can detect a fastening object attached to the original document MS.

### ASPECTS OF THE PRESENT DISCLOSURE

A description is given below of some aspects of the present disclosure.

### Aspect 1

In Aspect 1, an automatic document feeder includes a document stacker on which a document is placed, a document conveyor to convey the document placed on the document stacker, along a document conveyance path, a sound generator disposed on the document conveyance path and having a protruding shape or a recessed shape to a plane of the document conveyance path, a sound collector to collect sound when the sound generator and a fastening object attached to the document contact each other, and a prediction unit to predict whether the fastening object is attached to the document, based on the sound collected by the sound collector. Multiple sound generators including the sound generator are disposed serially or intermittently from one end to an opposite end in the width direction of the document conveyance path.

### Aspect 2

In Aspect 2, in the automatic document feeder according to Aspect 1, each of the multiple sound generators includes a first face that extends from the surface of the document conveyance path in the vertical direction, and a sloped face extending from an end of the first face to the surface of the document conveyance path in the vertical direction. The multiple sound generators are disposed at intervals in a conveyance direction of the document.

### Aspect 3

In Aspect 3, the automatic document feeder according to Aspect 1 further includes a rib on the document conveyance path and extending along the conveyance direction of the document. Each of the multiple sound generators has a recess in the surface of the document conveyance path. At least one of the multiple sound generators is disposed on a top face of the rib.

Aspect 4 In Aspect 4, in the automatic document feeder according to Aspect 1, the sound generator having the protrusion includes a plate member having a sloped face, and an elastic member supporting the plate member to be movable in a direction orthogonal to the surface of the document conveyance path.

### Aspect 5

In Aspect 5, in the automatic document feeder according to any one of Aspects 1 to 4, the sound generator has a cutout portion in a contact face with the document or a rough surface that has a surface roughness greater than the surface roughness of the document conveyance path.

### Aspect 6

In Aspect 6, the automatic document feeder according to Aspect 1 or Aspect 2 further includes ribs disposed on the document conveyance path and extending in a conveyance direction of the document. The ribs are disposed at intervals in the width direction of the document conveyance path. Each of the multiple sound generators has a protrusion protruding toward the surface of the document conveyance path. The multiple sound generators are disposed to fill a gap between adjacent ribs in the width direction of the document conveyance path. The height of the sound generator to the surface of the document conveyance path is lower than the surface of the document conveyance path.

### Aspect 7

In Aspect 7, the automatic document feeder according to Aspect 4 includes an opposing member disposed facing the plate member above the plate member.

### Aspect 8

In Aspect 8, in the automatic document feeder according to Aspect 2, the multiple sound generators are disposed at different intervals in a conveyance direction of the document.

### Aspect 9

In Aspect 9, an image forming apparatus includes the automatic document feeder according to any one of Aspects 1 to 8, and an image forming device to form an image on a medium.

### Aspect 10

In Aspect 10, an automatic document feeder includes a document stacker, a document conveyor, a sound generator, a sound collector, and circuitry. The document stacker is a receptacle on which a document is placed. The document conveyor conveys the document on the document stacker along a document conveyance path in a conveyance direction. The sound generator is disposed on a surface of the document conveyance path, the sound generator having a protrusion or a recess protruding or recessed from the surface of the document conveyance path and extending continuously or intermittently from one end to another end of the document conveyance path in a width direction orthogonal to the conveyance direction. The sound collector collects sound generated by contact between the sound generator and a fastening object attached to the document. The circuitry is to predict whether the fastening object is attached to the document, based on the sound collected by the sound collector.

### Aspect 11

In Aspect 11, the automatic document feeder according to Aspect 10 further includes multiple sound generators including the sound generator. The multiple sound generators are disposed at intervals in the conveyance direction. Each of the multiple sound generators includes a first face and a second face. The first face is raised vertically from the surface of the document conveyance path. The second face is inclined relative to the first face and connecting an edge of the first face and the surface of the document conveyance path.

### Aspect 12

In Aspect 12, in the automatic document feeder according to Aspect 11, the multiple sound generators are disposed at different intervals in the conveyance direction.

### Aspect 13

In Aspect 13, the automatic document feeder according to Aspect 10 further includes a rib on the document conveyance path and extending in the conveyance direction. The sound generator has the recess recessed from a surface of the rib.

### Aspect 14

In Aspect 14, in the automatic document feeder according to any one of Aspects 10 to 13, the protrusion of the sound generator includes, a plate having a sloped face, and an elastic member movably supporting the plate in a direction orthogonal to the surface of the document conveyance path.

### Aspect 15

In Aspect 15, the automatic document feeder according to Aspect 10 or 11 further includes an opposing member above the plate and facing the plate.

### Aspect 16

In Aspect 16, in the automatic document feeder according to Aspect 13, the sound generator has a cutout in a contact face between the sound generator and the document or a rough face having a surface roughness greater than a surface roughness of the document conveyance path.

### Aspect 17

In Aspect 17, the automatic document feeder according to Aspect 11 further includes a rib on the document conveyance path and extending in a conveyance direction of the document. Multiple ribs including the rib are disposed at intervals in the width direction of the document conveyance path. The sound generator has the protrusion protruding toward the surface of the document conveyance path. The sound generator is disposed to fill a gap between adjacent ribs in the width direction of the document conveyance path. A height of the one sound generator to the surface of the document conveyance path is lower than a surface of the document conveyance path.

### Aspect 18

In Aspect 18, an image forming apparatus includes the automatic document feeder according to any one of Aspects 10 to 17, and an image forming device to form an image on a medium.

### Aspect 19

In Aspect 19, an automatic document feeder includes a document conveyance path, a protrusion, and a sound collector. The document conveyance path is a path in which a document is conveyed to a reading position to read the document. The protrusion extends in a direction orthogonal to a conveyance direction of the document in the document conveyance path and protruding upward toward a downstream side from an upstream side in the document conveyance path of the conveyance direction of the document, to contact a surface of the document that conveys in the document conveyance path. The sound collector collects sound of the document that conveys in the document conveyance path. Conveyance of the document to be conveyed to the reading position is stopped based on the sound collected by the sound collector.

### Aspect 20

In Aspect 20, in the automatic document feeder according to Aspect 19, multiple protrusions including the protrusion are disposed in the conveyance direction of the document in the document conveyance path.

### Aspect 21

In Aspect 21, the automatic document feeder according to Aspect 20 further includes a rotary member to contact the document in the document conveyance path. The multiple protrusions are on both sides of the document conveyance path in a direction orthogonal to the conveyance direction of the document, interposed by the rotary member.

Aspect 22 In Aspect 22, an image forming apparatus includes the automatic document feeder according to any one of Aspects 19 to 21, and an image forming device to form an image on a medium.

The embodiments have been described above, but the embodiments are presented as examples, and the present disclosure is not limited to the embodiments. Thus, numerous additional modifications and variations are possible in light of the above teachings. For example, elements and/or features of different illustrative embodiments may be combined with each other and/or substituted for each other within the scope of the present invention. These embodiments and variations are included in the scope and gist of the invention and are included in the invention described in the claims and the equivalent scope thereof.

The present disclosure is not limited to specific embodiments described above, and numerous additional modifications and variations are possible in light of the teachings within the technical scope of the appended claims. It is therefore to be understood that the disclosure of this patent specification may be practiced otherwise by those skilled in the art than as specifically described herein, and such, modifications, alternatives are within the technical scope of the appended claims. Such modifications are also included in the technical scope of the present disclosure.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An automatic document feeder comprising:
a document stacker on which a document is placed;
a document conveyor to convey the document on the document stacker along a document conveyance path in a conveyance direction;
a sound generator on a surface of the document conveyance path, the sound generator having a protrusion or a recess:
protruding or recessed from the surface of the document conveyance path; and
extending continuously or intermittently from one end to another end of the document conveyance path in a width direction orthogonal to the conveyance direction;
a sound collector to collect sound generated by contact between the sound generator and a fastening object attached to the document; and
circuitry configured to predict whether the fastening object is attached to the document, based on the sound collected by the sound collector.

2. The automatic document feeder according to claim 1, further comprising:
multiple sound generators including the sound generator, the multiple sound generators disposed at intervals in the conveyance direction,
wherein each of the multiple sound generators includes:
a first face raised vertically from the surface of the document conveyance path, and
a second face inclined relative to the first face and connecting an edge of the first face and the surface of the document conveyance path.

3. The automatic document feeder according to claim 2,
wherein the multiple sound generators are disposed at different intervals in the conveyance direction.

4. The automatic document feeder according to claim 1, further comprising a rib on the document conveyance path and extending in the conveyance direction,
wherein the sound generator has the recess recessed from a surface of the rib.

5. The automatic document feeder according to claim 1,
wherein the protrusion of the sound generator includes:
a plate having a sloped face; and
an elastic member movably supporting the plate in a direction orthogonal to the surface of the document conveyance path.

6. The automatic document feeder according to claim 5, further comprising an opposing member above the plate and facing the plate.

7. The automatic document feeder according to claim 1,
wherein the sound generator has:
a cutout in a contact face between the sound generator and the document; or
a rough face having a surface roughness greater than a surface roughness of the document conveyance path.

8. The automatic document feeder according to claim 1, further comprising a rib on the document conveyance path and extending in a conveyance direction of the document,
wherein multiple ribs including the rib are disposed at intervals in the width direction of the document conveyance path,
the sound generator has the protrusion protruding toward the surface of the document conveyance path,
the sound generator is disposed to fill a gap between adjacent ribs in the width direction of the document conveyance path, and
a height of the one sound generator to the surface of the document conveyance path is lower than a surface of the document conveyance path.

9. An image forming apparatus comprising:
the automatic document feeder according to claim 1; and
an image forming device to form an image on a medium.

10. An automatic document feeder comprising:
a document conveyance path in which a document is conveyed to a reading position to read the document;
a protrusion extending in a direction orthogonal to a conveyance direction of the document in the document conveyance path and protruding upward toward a downstream side from an upstream side in the document conveyance path of the conveyance direction of the document, to contact a surface of the document that conveys in the document conveyance path; and
a sound collector to collect sound of the document that conveys in the document conveyance path,
wherein conveyance of the document to be conveyed to the reading position is stopped based on the sound collected by the sound collector.

11. The automatic document feeder according to claim 10,
wherein multiple protrusions including the protrusion are disposed in the conveyance direction of the document in the document conveyance path.

12. The automatic document feeder according to claim 11, further comprising a rotary member to contact the document in the document conveyance path,
wherein the multiple protrusions are on both sides of the document conveyance path in a direction orthogonal to the conveyance direction of the document, interposed by the rotary member.

13. An image forming apparatus comprising:
the automatic document feeder according to claim 10; and
an image forming device to form an image on a medium.
